(19) United States
(12) Patent Application Publication
(10) Pub. No.: US 2003/0130954 A1
(43) Pub. Date: Jul. 10, 2003

(54) Postal applications including digital watermarks

(76) Inventors: J. Scott Carr, Tualatin, OR (US); Geoffrey B. Rhoads, West Linn, OR (US); Burt W. Perry, Lake Oswego, OR (US); Phillip Andrew Seder, Portland, OR (US); Lorie R. Clements, Portland, OR (US); Neil E. Lofgren, White Salmon, WA (US)

Correspondence Address: DIGIMARC CORPORATION, 19801 SW 72ND AVENUE, SUITE 100, TUALATIN, OR, 97062, US

(21) Appl. No.: 10/301,528

(22) Filed: Nov. 20, 2002

Related U.S. Application Data
(63) Continuation-in-part of application No. 10/244,143, filed on Sep. 12, 2002.
(63) Continuation-in-part of application No. 09/343,104, filed on Jun. 29, 1999.
(63) Continuation-in-part of application No. 09/314,648, filed on May 19, 1999.
(63) Continuation-in-part of application No. 09/567,405, filed on May 8, 2000.
(63) Continuation-in-part of application No. 09/629,649, filed on Aug. 1, 2000.
(63) Continuation-in-part of application No. 09/689,289, filed on Oct. 11, 2000.
(63) Continuation-in-part of application No. 09/343,104, filed on Jun. 29, 1999.
(63) Continuation-in-part of application No. 09/314,648, filed on May 19, 1999.
(63) Continuation-in-part of application No. 09/567,405, filed on May 8, 2000.
(63) Continuation-in-part of application No. 09/629,649, filed on Aug. 1, 2000.
(63) Continuation-in-part of application No. 09/689,289, filed on Oct. 11, 2000.
(63) Continuation-in-part of application No. 09/939,298, filed on Aug. 24, 2001.
(63) Continuation-in-part of application No. 09/127,502, filed on Jul. 31, 1998, now Pat. No. 6,345,104.
(60) Provisional application No. 60/332,512, filed on Nov. 21, 2001.
(60) Provisional application No. 60/323,148, filed on Sep. 17, 2001.

(51) Int. Cl. G06F 17/60

(52) U.S. Cl. 705/60

(57) ABSTRACT

The present invention relates to postal metering devices and mail systems that variously employ digital watermarking techniques. In one implementation we provide on an envelope a marketing image in addition to postage indicia. The marketing image includes a digital watermark embedded therein. The watermark includes a link to access information that is associated with the envelope's sender. In some cases the digital watermark is fragile, allowing us to determine whether the marking image or postal indicia is authentic.

### RELATED APPLICATION DATA

This patent application claims the benefit of U.S. Provisional Patent Application No. 60/332,512, filed Nov. 21, 2001.

This application is a continuation in part of U.S. patent application Ser. No. 10/244,143, filed Sep. 12, 2002, which claims the benefit of U.S. Provisional Application No. 60/323,148. The Ser. No. 10/244,143 application is also a continuation-in-part of each of the following applications: Ser. No. 09/343,104, filed Jun. 29, 1999; Ser. No. 09/314,648, filed May 19, 1999; Ser. No. 09/567,405, filed May 8, 2000; Ser. No. 09/629,649, filed Aug. 1, 2000; and Ser. No. 09/689,289, filed Oct. 11, 2000.

This application is also a continuation-in-part of each of the following applications: Ser. No. 09/343,104, filed Jun. 29, 1999; Ser. No. 09/314,648, filed May 19, 1999; Ser. No. 09/567,405, filed May 8, 2000; Ser. No. 09/629,649, filed Aug. 1, 2000; Ser. No. 09/689,289, filed Oct. 11, 2000, and Ser. No. 09/939,298, filed Aug. 24, 2001, which is a continuation-in-part of Ser. No. 09/127,502, filed Jul. 31, 1998.

This application is related to the following U.S. patent application Ser. No. 09/629,401, filed Aug. 1, 2000; Ser. No. 09/343,101, filed Jun. 29, 1999; and Ser. No. 09/552,998, filed Apr. 19, 2000.

Each of the above U.S. Patent documents is incorporated herein by reference.

### FIELD OF THE INVENTION

The present invention relates to digital watermarking systems and methods, and is particularly illustrated with reference to digital watermarking mail and other deliverables.

### BACKGROUND AND SUMMARY OF THE INVENTION

The world has changed. Recent events have led many to question fundamental services—including the mail. The staggering number of suspicious mail reports have stymied police and HAZMAT teams around the country. People are apprehensive to open their mail. Bio-terrorism has shut down postal facilities—as mail is impounded for cleansing. And people are simply tossing out questionable mail items.

A solution is needed to provide mail users with increased security. Solutions are also needed to allow mail and delivery recipients to verify sender identity and to safeguard against enclosed mail.

Digital watermarking can provide some solutions.

Digital watermarking technology, a form of steganography, encompasses a great variety of techniques by which plural bits of digital data are hidden in some other object, preferably without leaving human-apparent evidence of alteration. The object can be digital (e.g., images, audio or video) or physical.

Digital watermarking may be used to modify an object to embed a machine-readable code into the object. The object may be modified such that the embedded code is imperceptible or nearly imperceptible to the user, yet may be detected through an automated detection process.

Digital watermarking systems typically have two primary components: an embedding component that embeds the watermark in an object, and a reading component that detects and reads the embedded watermark. The embedding component embeds a watermark by altering data samples of or associated with the object. If the object is a physical object, the embedding can be achieved through surface texturing or varying surface micro-topology, or through embedding an image that is printed or etched onto the object's surface. The reading component analyzes content to detect whether a watermark is present. In applications where the watermark encodes information, the reading component extracts this information from the detected watermark. Commonly assigned U.S. patent application Ser. No. 09/503,881, filed Feb. 14, 2000, discloses various encoding and decoding techniques. U.S. Pat. Nos. 6,122,403, 5,841,978 and 5,862,260 disclose still others. Each of these U.S. patent documents is herein incorporated by reference. Of course, artisans know many other steganographic encoding techniques that may be suitably interchanged with some embedding aspects of the present invention.

Embedded machine-readable code can be used to link to or otherwise identify related information. In one illustrative example, a document is embedded with an identifier (or machine readable code). The identifier is extracted by a watermark-reading device and is passed to a central server. The central server includes (or communicates with) a database with related information. The related information is indexed via watermark identifiers. Such related information may include a URL, web address, IP address, and/or other information. The extracted identifier can be used to interrogate the database to locate corresponding related information, such as a URL. The URL is passed from the central server to the reading device. The URL is used to direct a web browser to a website corresponding to the URL. Or the embedded data may include sufficient information itself to direct a web browser without first querying a database. U.S. patent application Ser. No. 09/571,422 discloses various applications and examples of such linking techniques.

According to one aspect of the invention, we provide a method of marking an item that will travel in a mail system. The item includes at least a first outer surface and a second outer surface. The method includes the steps of: at a postage meter receiving a first image, wherein the first image includes at least a first digital watermark embedded therein; with the postage meter, printing the first image onto a first area of the first outer surface; and with the postage meter, printing postage indicia onto a second area of the first outer surface. In some implementations, the first image includes a so-called marketing image, which may include advertising, logos, graphics, etc. The first digital watermark may be fragile or robust.

According to another aspect of the invention, a postage meter includes electronic processing circuitry, a printer, a communications bus, and memory in communication with the electronic processing circuitry via the communications bus. The memory includes instructions stored therein for processing on the electronic processing circuitry. The instructions including instructions to embed a digital watermark in a marketing image, wherein the marketing image is distinct from postage indicia that is to be printed, and control the printer to print both the embedded marketing image and the postal indicia.

The foregoing and features and advantages of the present invention will be more readily apparent from the following detailed description, which proceeds with reference to the accompanying drawings.

### BRIEF DESCRIPTION OF THE DRAWINGS

FIG. 1 is a block diagram of a postage meter according to one aspect of the present invention.

FIG. 2 illustrates a flow diagram for a sender identification method according to the present invention.

FIG. 3 shows a system according to one illustrative aspect of the present invention.

### DETAILED DESCRIPTION

Improving Postal Security

Mail users need a method to verify sender information. Increased security can be provided when sender identity (or a sender status) is verified. Mail users and postal inspectors also need methods to help identify duplicate (e.g., copied) mail items and postage indicia. With our inventive methods, a mail user can disregard duplicate mail items and an inspector can recognize counterfeited postal indicia.

For some of the following implementations, a postal metering device (hereafter “postal meter” or “postage meter”) includes a networked computer (e.g., including electronic processing circuitry and memory) with printing capabilities that permits printing over the full face or selective portions of an envelope (or other substrate/packaging). The printing may occur on one or both sides of an envelope. Instead of a networked postal meter, some implementations of our invention envision a postal meter including a stand-alone computer or hardware (and/or software) device with printing capabilities. (Of course, alternative definitions for a postal meter as provided in the incorporated-by-reference patent documents may be used where appropriate.). A postal meter is preferably arranged to print various patterning, postal indicia, images and/or artwork. No longer must a printed postal mark (or indicia) have a strictly utilitarian look—printing of any form can represent a postal value.)

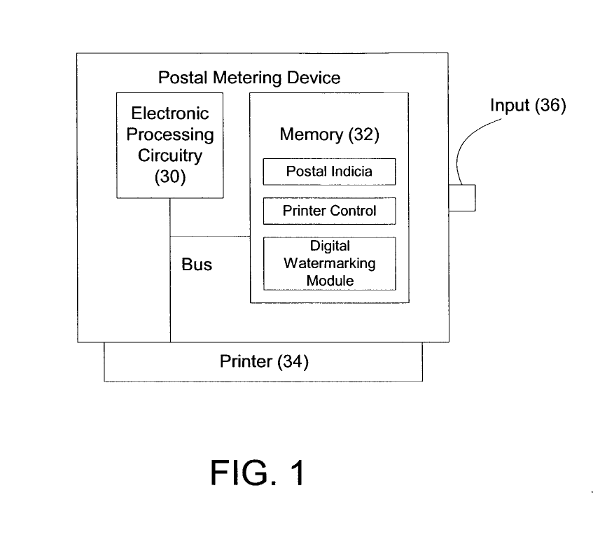

In some of the following implementations, with reference to FIG. 1, a postage meter may include electronic processing circuitry (30), memory (32), system bus and a printer (34). The memory may include printer control instructions (e.g., a device driver or controller), postage indicia information or instructions, and in some cases, digital watermarking embedding instructions. The postage meter device may also include an input (36), e.g., for communicating with a network or storage device (e.g., SmartCard).

Postal indicia need not be limited to the upper right hand corner of an envelope. It can extend over some or the entire envelope—both front and/or back. Postal printing may be printed for aesthetic purposes—and not just simply for postage mark—or may convey advertising or other promotional images and messages. As with postal meter tape (e.g., sticker), the artwork can be applied to an adhesive-backed medium that is affixed to an envelope, or can be applied directly to the envelope.

Some postal meters can provide a “marketing image” in a “marketing space” (and/or a “mailer space”) near or adjacent to printed postage indicia. A marketing image can take many forms, e.g., a company logo, graphic, advertisement, design, picture, image, text, indicia, trademark, etc. Postal meters can be loaded or programmed with an appropriate marketing image, which is then printed onto an envelope, sticker or mailing package.

Our inventive improvements provide a marketing image that is embedded with steganographic encoding, e.g., in the form of a digital watermark. An advantage of hosting a digital watermark in a marketing image is that the watermark can be added to marketing images without changing the firmware/hardware that are in deployed postal meters, since many of the deployed postal meters are typically equipped to process and apply marketing images. Marketing images can be digitally watermarked and stored as an electronic or digital file. The watermarked digital file is then uploaded into a deployed postal meter. The uploading can be accomplished with a communications link, e.g., provided over the internet or network, or through direct communications with a storage module such as a SmartCard, optical disk, magnetic disk, electronic memory circuit, etc.

One implementation of the present invention embeds a so-called fragile watermark in a marketing image. A fragile watermark is designed to be lost, or to degrade predictably, when the data set into which it is embedded is processed in some manner, such as signal processing, scanning/printing, etc. A watermark may be made fragile in numerous ways. One form of fragility relies on low watermark amplitude. That is, the strength of the watermark is only marginally above the minimum needed for detection. If any significant fraction of the signal is lost, as typically occurs in photocopying operations, the watermark becomes unreadable. Another form of fragility relies on the watermark's frequency spectrum. High frequencies are typically attenuated in the various sampling operations associated with digital scanning and printing. Even a high amplitude watermark signal can be significantly impaired, and rendered unreadable, by such photocopying operations. Other fragile watermarking techniques and various applications of such are even further disclosed, e.g., in assignee's U.S. patent application Ser. Nos. 09/234,780, 09/433,104, 09/433,104, 09/498,223, 09/562,516, 09/567,405, 09/625,577, 09/645,779 and 10/115,582. Each of these applications is herein incorporated by reference. Of course, other fragile watermarking techniques that are know to artesian can be suitably interchanged with this aspect of the present invention.

Once a fragile watermark is embedded in a marketing image, a mail user, e.g., a corporate mailroom, mail processing center, postal inspector, and even consumers, can identify a duplicate or counterfeit. A duplicate is identified when an expected fragile watermark is unrecoverable, or when the fragile watermark is recovered in a degraded form. The mail user can disregard duplicate mail items since they have been copied and may be viewed as a potential threat. Or an inspector can recognize counterfeited postal indicia.

Another aspect of the present invention is to embed a “robust” watermark in the marketing image. Unlike a fragile watermark, a robust watermark is preferably designed to survive typical signal processing, copy/printing, analog-to-digital-to-analog conversion, etc. In some implementations we embed both a robust watermark and a fragile watermark in the marketing image.

In our preferred “robust” embodiment, the robust watermark includes an identifier. The identifier is preferably unique (or “serialized”) to an individual mail sender. Identifying the sender as such will allow mail recipients to verify sender identity. The watermark identifier is preferably registered in a central database. In another implementation, the watermark identifier is associated with information about the intended mail sender (e.g., a postal meter owner). An example of the associated information is a URL, internet or network address or a network resource location. The database can also associate other information such as the issue date of the watermark, a postage meter serial number, a sender identification number, a timestamp, etc.

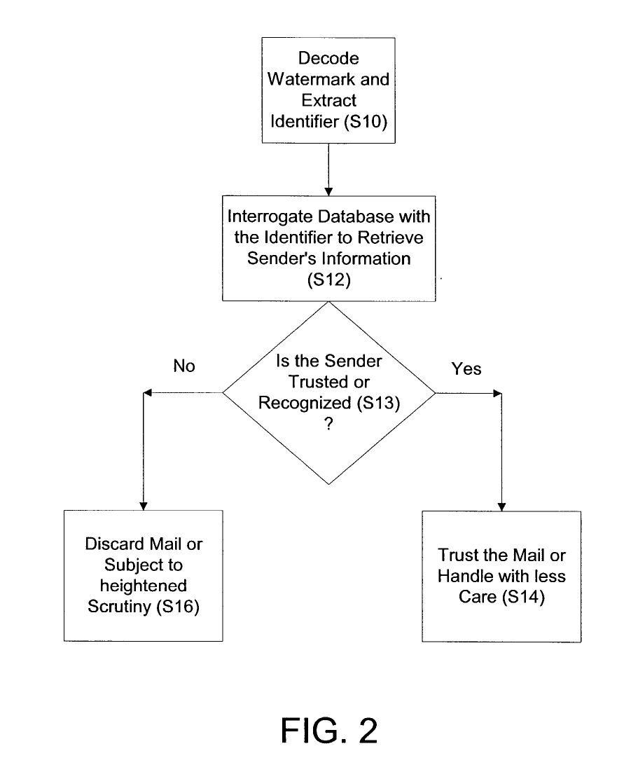

An advantage of embedding a robust watermark in the marketing image is to provide a link from the mail item to the sender information. This link can help a mail recipient to authenticate or identify the mail item's sender. For example, a robust digital watermark can include an identifier. The robust digital watermark is conveyed (or printed) to envelope or package, e.g., perhaps via an embedded marketing image. Prior to mailing, the watermark identifier is associated, perhaps in a database, with sender information. The database association can be part of the mailing process, e.g., a can even provide a seal of approval or stamp of verification. The sender information may include a verified address, background check information, a trustworthiness indictor, biometric check, etc. With reference to FIG. 2, a mail recipient can decode the watermark to extract the watermark identifier (S10). The identifier is used to retrieve the sender information (S12). In some cases, the recipient only receives an indication of whether the sender's address and/or background were verified. If the sender is trusted or recognized (as determined in step S13) the mail is trusted or handled with less care (S14), otherwise the mail is discarded or subjected to heightened scrutiny (S16).

A foreseeable application is to distribute a watermarked marketing image to a postal meter. Distribution can be accomplished via an internet (or other network) download to the postal meter. As an alternative distribution method, a watermarked image is loaded in a SmartCard and then the loaded SmartCard is provided to a postal meter owner for loading the watermarked image into the meter. Or a SmartCard can be remotely refreshed via an internet or network download with a new watermarked image. (Instead of using a SmartCard, another storage module such as electronic circuitry, optical memory, magnetic memory, etc. can be used.).

In an alternative implementation, SmartCard “activation” is required before the stored watermarked marketing image can be accessed or uploaded to a postal meter. To activate the SmartCard, a SmartCard owner contacts (e.g., calls or communicates on-line) with an activation service or web site (hereafter collectively “activation service”). The activation service creates an activation code. This activation code is used in connection with the SmartCard to activate or access the stored, watermarked marketing image. The code can be input directly to the SmartCard for activation. Alternatively, the code includes a key that is used to decrypt or otherwise unlock the stored marketing image. In this alternative, the stored marketing image may be freely accessible, albeit in a scrambled or encrypted form. The postal meter (or a computer in communication with the postal meter) uses the key to unscramble the marketing image.

The activation code can take many forms. One code form includes a hash of the postal meter number plus some form of sender information (e.g., sender account number, identification number, return address, sender identifier, etc.). To activate the SmartCard, the appropriate sender information as well as the postal meter number is presented to the SmartCard (or a SmartCard reading device/computer). Another code form includes an encryption/decryption key. Still another code form ties the SmartCard and/or marketing image to a particular postal meter (e.g., through a cryptographic permutation, concatenation, etc.). With this code form, the code is provided to the SmartCard by the postal meter itself. Only a corresponding postal meter can activate the SmartCard to access the marketing image.

Once a watermarked marketing image is loaded in a postal meter, envelopes printed by the meter can be printed to include the watermarked marketing image. In an optional implementation, the watermarked marketing image is time limit restricted. The time limit can take various forms, e.g., the time limit can be managed as information in a database. The database can be accessed via an identifier carried by the watermark. Before allowing access to the database by a mail recipient, however, the database (or a software application in communication with the database) checks to see if the time limit is stale (or expired). In some implementations the time limit is maintained in the database. In other implementations the time limit (e.g., an expiration date or “good-until” date) is carried by the watermark itself. A watermark reader can extract this expiration date and act accordingly. If the time limit is fresh, the mail recipient is provided with requested or designated information. Otherwise, if the time limit is not fresh, the mail recipient is prevented from accessing the related information.

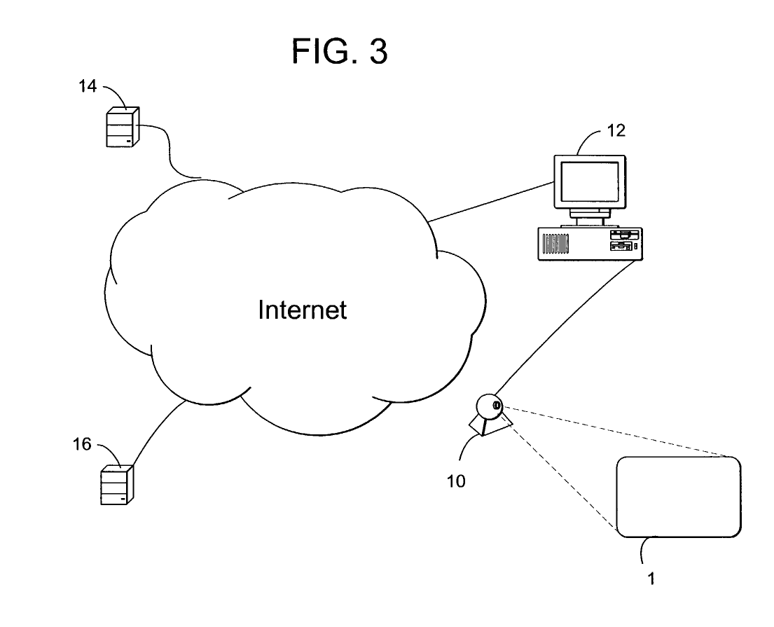

Watermark detectors can be strategically placed in post offices, offices and homes. With reference to FIG. 3, watermark detector 12 typically includes an input device 10, such as a digital camera, web camera, scanner, optical sensor, etc. The input device 10 captures an image of the watermarked marketing image 1. The watermark that is embedded in the marking image preferably includes an identifier or payload. The watermark detector 12 analyzes the captured image to recover the watermark identifier. In a first implementation, the identifier is communicated to a central database 14 where related information (e.g., URL, creation date, sender identification number, etc.) is retrieved. The URL may provide access to a web site (server) 16 or other network resource to indicate whether the marketing indicia was created on an authorized (or trusted) postal meter, or to identify the sender. (See FIG. 2 for even further details regarding a sender verification process.). One possible response would be to communicate to the mail recipient an “invalid sender” or “decommissioned meter” message. Of course, instead of redirecting the web browser with a URL, site 14 can provide the information itself.

In an alternative arrangement, multiple marketing images are generated and time stamped. In a fully connected system (e.g., a system where postal meters communicate with a central database), a postal meter communicates with the database at least at the start of each day to download a new watermarked marketing image. This new watermarked image preferably includes an identifier which can be used to link to database (or web site) information.

In some implementations the watermark or database includes a timestamp. Thus, when a mail recipient receives an envelope including a watermarked marketing image, the timestamp enables the mail recipient to determine which day the watermarked image was generated. The marketing image creation date (timestamp) can be cross-correlated with the postage indicia (e.g., date stamp) as an additional authentication check. If the two dates (i.e., the marketing image timestamp and the postal indicia date stamp) do not coincide, the envelope is considered not authentic. In some cases the postage indicia includes a watermark, perhaps with a date stamp. The marketing image watermark (timestamp) and the postage indicia watermark (date stamp) can be cross-correlated to determine authenticity. For example, if the timestamp and the date stamp do not coincide, then the marketing image and/or postage indicia may not be authentic. This cross-correlation can be performed using other information such as postage amount, sender information, intended recipient, etc.

Instead of embedding a marketing image with a watermark and then loading the watermarked image into a postal meter, the postal meter may alternatively include a watermark embedder. The watermark embedder provides the postal meter with the ability to embed a watermark in its printed images. Resulting watermarks may include an identifier that can be recorded in a central database. Information is stored in the database according to identifiers as discussed above. While not required, a postal meter watermark embedder is preferably a variable embedder—meaning that the embedder embeds a unique identifier for each printed image (or for a set of images) or according to an intended recipient.

To track and manage unique identifiers, a watermarked postal meter can communicate to a central database that it consumed a set of unique watermarked identifier, oh say identifier numbers n through p, from an allocated reserve on a given date (where n and p are integers and p>n). In some implementations the postal meter has an input to allow an identifier to be assigned to other information, such as intended recipient, sender information, date, postage, etc. In other implementations the postal meter embeds a timestamp for each usage of a generic identifier (e.g., an identifier assigned to a specific postal meter). A unique identifier is formed by the combination of the timestamp and generic identifier. The combination timestamp/general identifier is preferably recorded in a database.

A timestamp can be embedded into (or carried by) a digital watermark itself, instead of storing such information in the central database. Also a specific postal meter number and/or timestamp, or a zip code and timestamp, can be embedded directly into the marketing image as a watermark payload. A network or internet connection is not needed for a watermark verification or information gathering when using such a self-authenticating watermark.

In still a further alternative embodiment, the postal meter communicates with a central database each time it embeds a unique identifier, such that each marketing image contains a unique watermark (or a unique payload carried by the watermark). The embedding can occur in the postal meter, or on a computer where an image is embedded and then delivered to a postal meter for printing on an envelope, sticker or package.

In another embodiment, a marketing image includes multiple watermarks. In this implementation, the marketing image includes at least one fragile watermark and at least one robust watermark. Security promotion and consumer confidence elements of the overall system are driven by the robust watermark. The robust watermark is used to link to or otherwise access the sender information. Duplicate fraud deterrence (e.g., copying postal indicia or sender return address) is driven by the fragile watermark. Preferably, the ability to inspect (and detect) the fragile watermark is retained by qualified inspectors with secure access to a corresponding fragile watermark reader. In other implementations, a marketing image includes at least two fragile digital watermarks. A copy is determined through analysis of the two fragile digital watermarks, perhaps in comparison to one another.

In still another embodiment, a SmartCard is loaded with market images that each includes multiple watermarks. The watermarked images are stored on the SmartCard, but are not activated in the central database. (The term “activated” implies that a data record has been established that correspond to the watermark identifiers. Alternatively, “activated” may imply that a data record is established, but a flag is set to render the data record active or inactive.). During daily operations, the postal meter consumes watermarked images from the SmartCard in some order (e.g., randomly or sequentially). At the end of the day (or based on some other schedule) the postal meter uploads to the central database the images (e.g., the watermark identifiers or other image indicator) that have been used, thus activating the used images. Activation can include associating a date with the watermark identifier in preparation for downstream inspection of the mail item. Activation may optionally include associating sender and/or recipient information with the watermark identifier.

Of course, these inventive methods and systems find application beyond postal meters for use in the U.S. Postal System. Indeed, items delivered by Federal Express, UPS, etc. can be similarly digitally watermarked. A central database can track the information for the respective packages. A watermark can also be applied as a stamp on a ticket or certificate, especially those sent via the post to the buyer.

Non-Anonymous Mailing

Historically, sending regular mail has been an anonymous activity. A return address has never really been required for delivery. (Return addresses can even be faked or forged.). A sender simply drops a letter in the corner-mailbox and the letter will be delivered without regard to the sender's identity.

Sender accountability is needed in some settings. Indeed, a non-anonymous mailing system may greatly improve mail security. Digital watermarking can be used as a backbone in a “non-anonymous” mailing system. Consider our inventive system and methods outlined below.

In a first implementation of this aspect of the present invention, before accepting mail, a post office (or mailbox) requires a sender to identify herself. In one example, the sender presents a watermarked identification card for identification. The embedded card includes a watermark identifier that is uniquely associated with the sender. This watermark identifier can be used for identification (e.g., the watermark identifier is used to access corresponding identifying information such as a picture, biometric data, DNA, etc.) and transaction tracking (e.g., tracking envelopes or other items once deposited with the post office). In another example, the sender is identified via visual (photograph ID), biometrics, customer number, username and password/PIN, or other means. Alternatively, the sender is identified via a watermarked mail item, e.g., a mail item includes a digital watermark with sufficient information to identify (or link to identifying information) the bearer of the mail item. In other implementations, the watermark includes or links to biometric information that can be compared to the sender.

There are many inventive options once the sender is identified.

In a first option, mail is considered “secure” if the sender is identified as a “secure source.” Such a classification can be the result of a background check or based on government or organizational clearance. Or the secure source may result from a full disclosure of (and verification of) a sender's name, address, etc. The security classification can be stored in a database, which is interrogated with the extracted watermark identifier (or other sender identifier). Identifying mail as secure may render heighten screening unnecessary, while mail received from a non-secure source may be subjected to the heightened screening. For example, secure source mail can be carried by commercial aircraft, while non-secure mail must be shipped by truck.

In a second option, deposited mail is associated with the sender. For example, envelopes are digitally watermarked to include a unique identifier as discussed above (e.g., via postal indicia, marketing images or even other printing, e.g., background tint or patterns). Prior to acceptance into the postal system, however, the envelopes are scanned to extract the watermark identifier. Once extracted the watermark identifiers are associated with the sender. Hence, each mail item is associated with its sender. This information can be stored in a database.

In a third option, the sender's identification is used to verify a return address. For example, an embedded watermark carries (or links to) information to identify a sender's return address. The printed (or embedded) address can then be compared with the sender's address. Various business models can be established to promote such a return address verification model. For example if the return address is verifiable, the sender receives a postage discount. Alternatively, if the sender demands an anonymous service, they must pay a higher postage rate, and perhaps expect a slower delivery.

Transparent Mail

Bio-terrorism has recently been carried out with tainted letters. People are suspicious of mail from unrecognized sources. Some legitimate envelopes and packages are being discarded—the contents becoming lost. “Enclosed mail” (e.g., mail that is enclosed in an envelop or package) may be a thing of the past.

To address this new concern, we have invented a system and method to provide a more transparent and inspectable mail item. A postcard or other mailed document is digitally watermarked. The postcard is preferably not enclosed, as is a letter that is hidden in an envelope or package, allowing a recipient to inspect both sides of the card. (A mail user is afforded increased security with a postcard, as compared to a sealed envelope.). The post card's digital watermark includes an identifier or other data that is used to access or link to a network (e.g., internet) resource. The mail sender (or her agent) populates this network resource with information corresponding to the postcard. The corresponding information may include a PDF copy of a letter, a birthday card, prospectus, contract, etc., etc.

After receiving a digitally watermarked postcard, a mail recipient presents the postcard to a computer input device (e.g., web camera, scanner, CCD array, optical sensor, etc.). The input device captures an image of the postcard and conveys such to a computer. The computer preferably includes a memory and processing unit. The computer's processing unit executes digital watermark reading software stored in memory. (In one embodiment Digimarc's MediaBridge software, available from Digimarc Corporation in Tualatin, Oreg., USA, comprises the reading software. Of course, other suitable watermark reading software can be used.). The watermark detecting software extracts the watermark identifier from the captured postcard image. In one implementation, the watermark identifier is communicated from the computer to a central router (and database). The router interrogates a database with the watermark identifier to locate a corresponding URL (or other locator/address) for the sender's network resource. The router communicates the URL to the computer. The computer, in turn, directs its web browser with the URL. In a second implementation, the identifier includes a corresponding URL, which directs the computer's web browser instead of querying the router/database for a URL. (Other applicable linking implementations are further described in the above-mentioned Ser. No. 09/571,422 patent application.).

Security features can be optionally employed to regulate access to the sender's network site. Security features may be advantageous to help prevent an unintended mail recipient from accessing a network site. In one implementation, the mail recipient provides a key (e.g., an identifier, password/PIN, or encryption/decryption key) to enable access of the intended information. The key can be provided to the central database or to the sender's network site for verification. Access is granted only when the key is verified. The key can be provided by a recipient (keyboard entry, touch-screen, macro, or voice command) or automatically by the watermark detecting software and/or web browser. Or the key can be embedded in a watermarked card that is preferably unique to the mail recipient. The mail recipient is prompted to present the watermarked card to her input device for extracting and decoding. The extracted key is then communicated to the network site or to the central router. If the key matches the watermark identifier and/or the intended information the mail recipient gains access.

In another embodiment, an envelope or package includes a digital watermark embedded thereon. The watermark includes information that contains (or is used to link to) information to verify the envelope. One form of verification is a handling record of the item. Another form of verification is a signature or other identifier embedded in the mailed item, which identifies the item's sender or indicates whether the item traveled in a secure channel.

Alternative Embodiments

While some of the preceding discussion focuses on watermarking “marketing images,” the present invention is not so limited. Indeed, other envelope/packaging and images can host digital watermarks. These areas include the postage area/indicia, mailer images, stamps, cancellation marks, bulk mailer indicia, and postmarks. For example, stamps can be serialized with a digital watermark during their normal printing cycle. The stamps can be associated with a sender upon purchase or mailing. Additionally, the present invention is not limited to watermarking postal metering indicia. Instead, envelopes, mailing labels, invoices, packaging, etc. can be embedded with digital watermarks to facilitate the features discussed above.

While some of the above embodiments envision gathering information from a database via a watermark identifier, the present invention is not so limited. Indeed, a watermark may include a payload capacity sufficient to convey the corresponding database information, or a subset of the corresponding database information.

Of course, it should be appreciated that the “Improving Postal Security” section of this disclosure is not limited to embodiments employing postal meters. Indeed, our inventive watermarking techniques are applicable to other postage devices, such as Internet-based postage devices.

Some aspects of the present invention combine both a fragile and a robust watermark. Placement of these marks can be varied. For example, a marketing image may include both the fragile and robust watermark. Alternatively, the robust mark can be placed in the marketing space while the fragile mark is embedded in the postage indicia, or vice versa. Or one of the watermarks may be embedded in an envelope or label, etc.

### CONCLUSION

The foregoing are just exemplary implementations of the present invention. It will be recognized that there are a great number of variations on these basic themes. The foregoing illustrates but a few applications of the detailed technology. There are many others.

We note that digital postage technology is available from a number of vendors including Pitney Bowes, E-Stamp, Stamps.com and Escher Laboratories (of Escher Group, Ltd.), and is detailed in various patent publications including U.S. Pat. Nos. 5,982,506, 5,825,893, 5,819,240, 5,801,364, 5,774,886, 5,682,318, 5,666,284, 5,978,781, and WO 99/18543A1. Each of these patent documents is herein incorporated by reference.

To provide a comprehensive disclosure without unduly lengthening this specification, the above-mentioned patents and patent applications are herein incorporated by reference. The particular combinations of elements and features in the above-detailed embodiments are exemplary only; the interchanging and substitution of these teachings with other teachings in this application and the incorporated-by-reference patents/applications are also contemplated.

In view of the wide variety of embodiments to which the principles and features discussed above can be applied, it should be apparent that the detailed embodiments are illustrative only and should not be taken as limiting the scope of the invention.

What is claimed is:

1. A method for providing a non-anonymous mailing system comprising the steps of:
prior to accepting an item into the mailing system, determining an identifier that is steganographically associated with the item;
associating sender information with the identifier in a data record; and
providing access to the data record by a mail inspector or mail recipient, wherein access to the data record is facilitated at least in part by the identifier.

2. The method of claim 1, wherein the identifier is steganographically embedded in the item in the form of a digital watermark.

3. The method of claim 2, wherein the sender information comprises the sender's mailing address.

4. The method of claim 2, wherein the sender information comprises at least one of a result from a background check and biometric information.

5. The method of claim 2, further comprising the steps of:
decoding the digital watermark to obtain the identifier;
interrogating with the identifier a database to locate the data record; and
accessing the sender information in the data record.

6. The method of claim 2, wherein the item comprises an image or pattern, and wherein the digital watermark is embedded in the image or pattern at least in part through altering transform domain coefficients corresponding to the image or pattern.

7. A postage meter comprising:
electronic processing circuitry;
a printer;
a communications bus; and
memory in communication with the electronic processing circuitry via the communications bus, wherein said memory includes instructions stored therein for processing on the electronic processing circuitry, the instructions including instructions to:
embed a digital watermark in a marketing image, wherein the marketing image is distinct from postage indicia; and
control the printer to print both the embedded marketing image and the postal indicia.

8. The postage meter of claim 7, wherein the digital watermark includes an identifier.

9. The postage meter of claim 8 further comprising an input, said postage meter communicating with a network resource via the input to report at least one identifier that was printed.

10. A method of marking an item that will travel in a mail system, said item including at least a first outer surface, said method comprising the steps of:
at a postage meter receiving a first image, wherein the first image includes at least a first digital watermark embedded therein;
with the postage meter, printing the first image onto a first area of the first outer surface; and
with the postage meter, printing postage indicia onto a second area of the first outer surface.

11. The method of claim 10, wherein the first image comprises a second digital watermark embedded therein.

12. The method of claim 11, wherein the first digital watermark comprises a fragile digital watermark and the second digital watermark comprises a robust digital watermark.

13. The method of claim 12, wherein the robust digital watermark comprises an identifier.

14. The method of claim 13, further comprising the step of associating information in a data repository that is accessible via the identifier.

15. The method of claim 14, wherein the information comprises at least one of sender information, date, background check information, and intended recipient information.

16. The method of claim 10, wherein said first digital watermark comprises an identifier.

17. The method of claim 16, wherein the identifier comprises a timestamp including at least the date of which the first image is printed.

18. The method of claim 17, wherein the postage indicia comprises a date.

19. A method of verifying the authenticity of an item marked according to claim 18 comprising the steps of:
decoding the first digital watermark to obtain the identifier timestamp;
determining the postage indicia date;
cross-correlating the timestamp and the postage indicia date to determine whether the item is authentic.

20. The method of claim 10, wherein the first image comprises a marketing image.

21. The method of claim 10, wherein the first image is received via a network connection.

22. The method of claim 10, wherein the first image is received via communication with a SmartCard or memory device.

23. The method of claim 22, wherein the first image is received only after presenting an authorization code.

24. The method of claim 23, wherein the first image is encrypted and the authorization code is used to decrypted the first image.

25. A method of providing a transparent mail system comprising the steps of:
steganographically encoding a postcard with multi-bit data, wherein the multi-bit data includes an identifier, and wherein the encoding is machine-readable but generally imperceptible to a human observer of the postcard;
associating the identifier with a network resource;
populating the network resource with information;
sending the encoded postcard to a recipient via the mail system; and
allowing the recipient to access to the information via the identifier only after authority to access the information has been determined.

26. The method of claim 25, wherein the steganographic encoding comprises digital watermarking.

27. The method of claim 25, wherein authority to access the information is permitted after success entry of a code.

28. The method of claim 27, wherein the code is unique to the recipient.

29. The method of claim 25, wherein authority to access the information is time-sensitive.
